(19) United States
(12) Patent Application Publication
(10) Pub. No.: US 2022/0226845 A1
(43) Pub. Date: Jul. 21, 2022

(54) Hybridized Shower Apparatus

(71) Applicant: Dwain Dennie, Jonesboro, GA (US)

(72) Inventor: Dwain Dennie, Jonesboro, GA (US)

(21) Appl. No.: 17/686,672

(22) Filed: Mar. 4, 2022

Related U.S. Application Data
(63) Continuation-in-part of application No. 17/579,906, filed on Jan. 20, 2022.
(60) Provisional application No. 63/199,731, filed on Jan. 20, 2021.

(51) Int. Cl. B05B 7/24; E03C 1/04; B05B 1/18

(52) U.S. Cl. CPC B05B 7/2491; B05B 1/18; E03C 1/0408

(57) ABSTRACT

A hybridized shower apparatus is a hygienic aid that is directed towards adding additional functions to a conventional shower by introducing a second dispensation mode, in addition to conventional water jets. The hybridized shower apparatus uses a first fluid supply and a second fluid supply connected to a fluid selection mechanism via a first conduit and a second conduit. The fluid selection mechanism is further connected to a first annular chamber and a second annular chamber positioned within a dispersal head. The fluid selection mechanism selectably pressurizes the first annular chamber or the second annular chamber with the first fluid supply and the second fluid supply, respectively. The selected fluid is subsequently dispensed through the dispersal head onto a target region, typically a user's head and shoulders.

### FIELD OF THE INVENTION

The present invention generally relates to a shower head or sprayer unit. More specifically, the present invention relates a means of dispensing multiple types of fluids from a hybridized shower unit.

### BACKGROUND OF THE INVENTION

Showering, or personal hygiene generally, typically involved both a wash and dry process—either by hot air or towel. Separating these two processes is conventionally necessary, as the shower stall or bathtub is neither equipped for nor is particularly comfortable to rest in while drying oneself. However, combining these two processes, or any other two separate processes (e.g., lathering-and-washing, washing-and-drying, etc.), provides time-saving benefits for any user. Further, the lack of repositioning during these processes may be particularly attractive for mobility-compromised users, such as the elderly or injured, who may be receiving hygienic care from a seated position. Permanent modification of an existing bathing or showering facility may be undesirable from cost and other standpoints. However, conventional shower facilities already encompass at least one capability (washing). It is therefore proposed that a modular, retrofittable unit configured to introduce a second function may be added to existing facilities to expand their function. More specifically, a means of providing at least one additional material supply and a means of dispensing said material in conjunction with conventional plumbing fixtures may be provided with a minimum of initial cost.

The present invention is intended to address problems associated with and/or otherwise improve on conventional devices through an innovative shower device that is designed to provide physically challenged people with mobility and a convenient, effective means of showering while incorporating other problem-solving features.

### BRIEF DESCRIPTION OF THE DRAWINGS

FIG. 1 is a perspective view of one embodiment of the present invention shown in an exemplary functional configuration using an upright shower chair.

FIG. 2 is a bottom-front-left perspective view of the present invention.

FIG. 3 is a bottom front left perspective view thereof.

FIG. 4 is a sectional view taken along line 4-4 in FIG. 3.

FIG. 5 is a detail view of area 5 in FIG. 4.

FIG. 6 is a detail view of area 6 in FIG. 4, wherein an exemplary fluid selection mechanism is shown with one fluid path is obstructed, and another fluid path is clear.

FIG. 7 is a detail view of area 7 in FIG. 4, wherein the exemplary fluid selection mechanism is shown in a reversed configuration from FIG. 6.

FIG. 8 is a top-perspective exploded view of an exemplary dispersal head.

FIG. 9 is a bottom-perspective exploded view of an exemplary dispersal head.

FIG. 10 is an enlarged view of an exemplary user control wherein warm water is selected for dispersal. Fluid flow paths are indicated in dashed-line and electronic control paths are indicated in dot-dashed line.

FIG. 11 is an enlarged view of an exemplary user control wherein no fluid is selected for dispersal. Fluid flow paths are indicated in dashed-line and electronic control paths are indicated in dot-dashed line.

FIG. 12 is an enlarged view of an exemplary user control wherein hot air is selected for dispersal. Fluid flow paths are indicated in dashed-line and electronic control paths are indicated in dot-dashed line.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

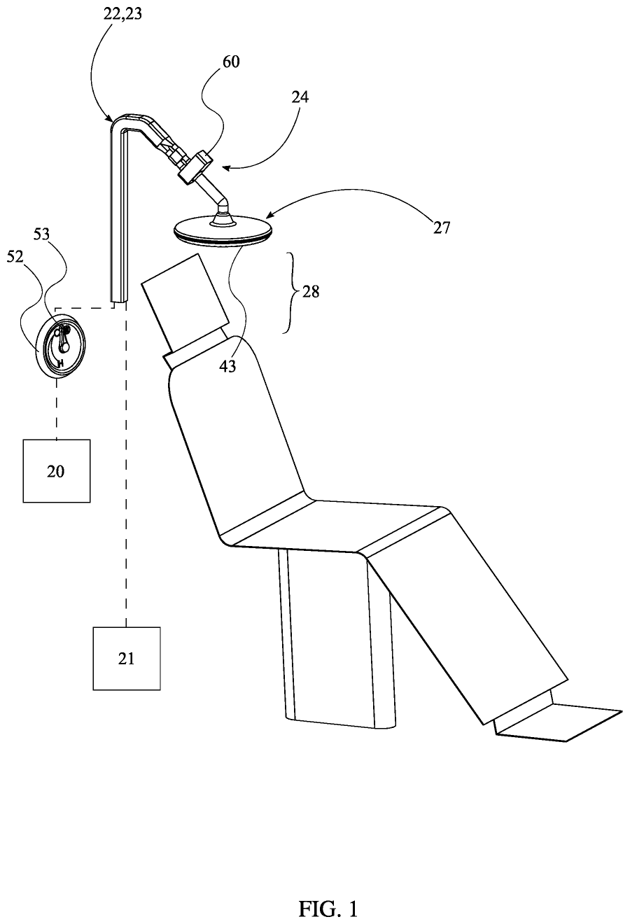

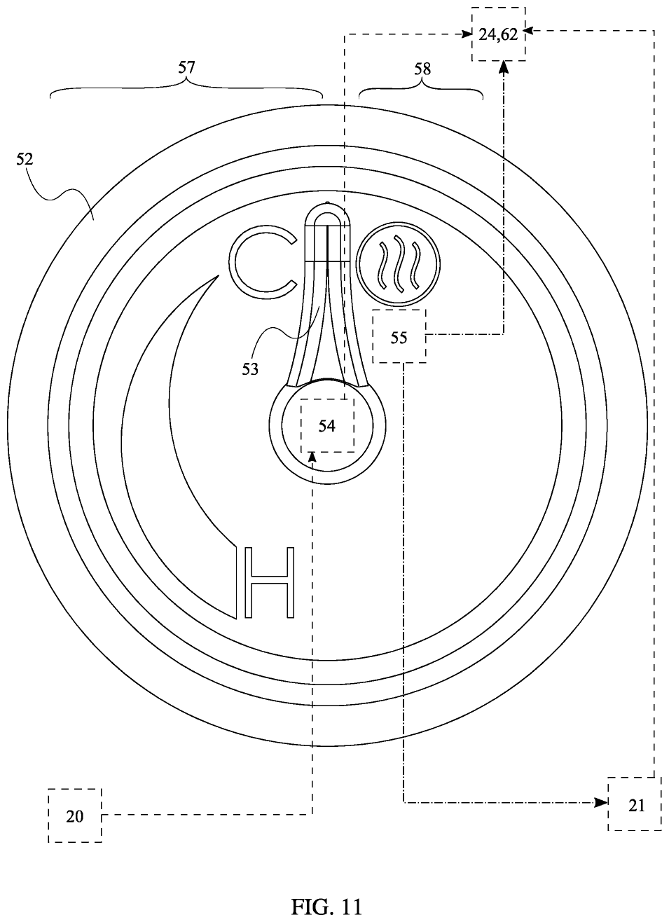

In reference to FIG. 1 through 12, the present invention is a hybridized shower apparatus comprising a first fluid supply 20, a second fluid supply 21, a first conduit 22, a second conduit 23, a fluid selection mechanism 24, a first annular chamber 25, a second annular chamber 26, and a dispersal head 27. The first fluid supply 20 and the second fluid supply 21 each constitute a pressurized source of fluids suitable for dispersal from a shower unit. In reasonably broad terms, ‘fluid’ refers to both liquids and gasses moving in a flow-state embodied by both liquids and gasses alike. Accordingly, the present invention is proposed as a means of both washing and drying a target region 28 through controlled, user-selectable dispensation from the first fluid supply 20 and the second fluid supply 21.

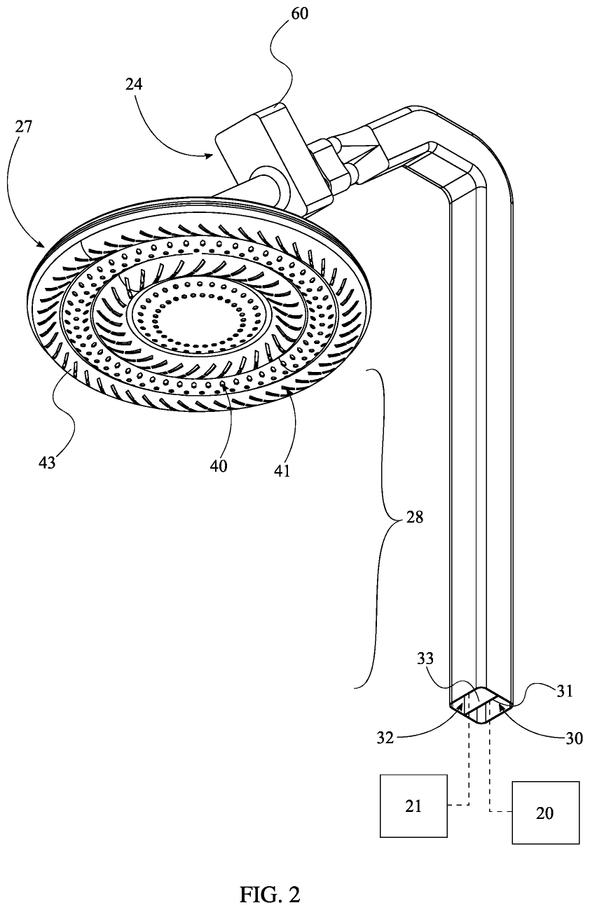

As indicated in FIGS. 1 and 2, the first conduit 22 is connected between the fluid selection mechanism 24 and the first fluid supply 20, and the second conduit 23 is connected between the fluid selection mechanism 24 and the second fluid supply 21. The first conduit 22 and the second conduit 23 each define a manifold pipe, tube, or similar means of conveyance individually suited to the first fluid supply 20 and the second fluid supply 21, respectively. Likewise, the fluid selection mechanism 24 defines any means of selectably obstructing the flow of materiel from the first conduit 22 or the second conduit 23 across the fluid selection mechanism 24, thereby enabling a user to control the type and variety of material ultimately dispersed into the target region 28. This is typically used to combined phases of a hygienic shower without replacing the shower unit or using other equipment, e.g., washing the target region 28 with water then drying with blasts of heated air.

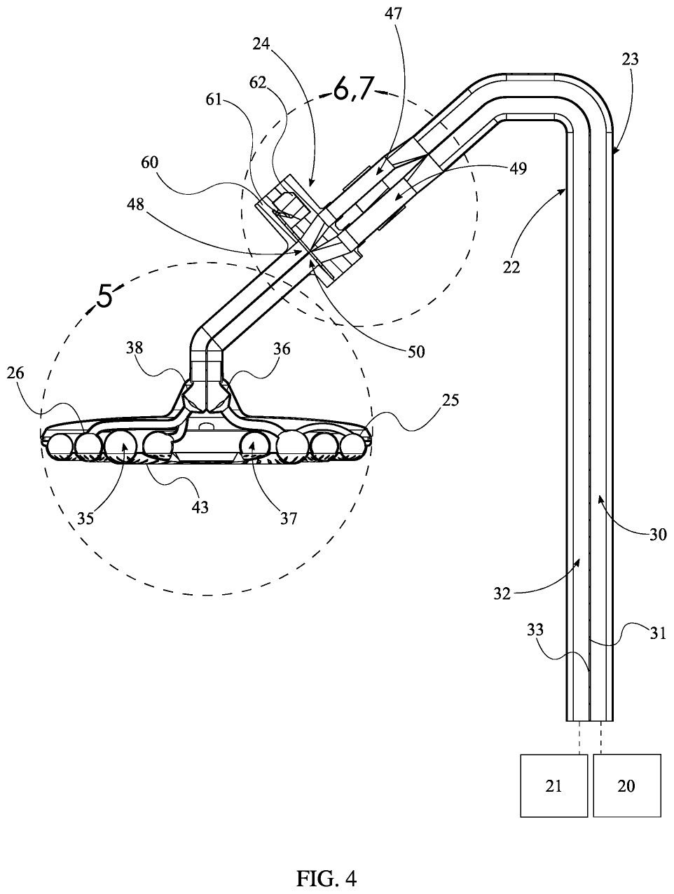

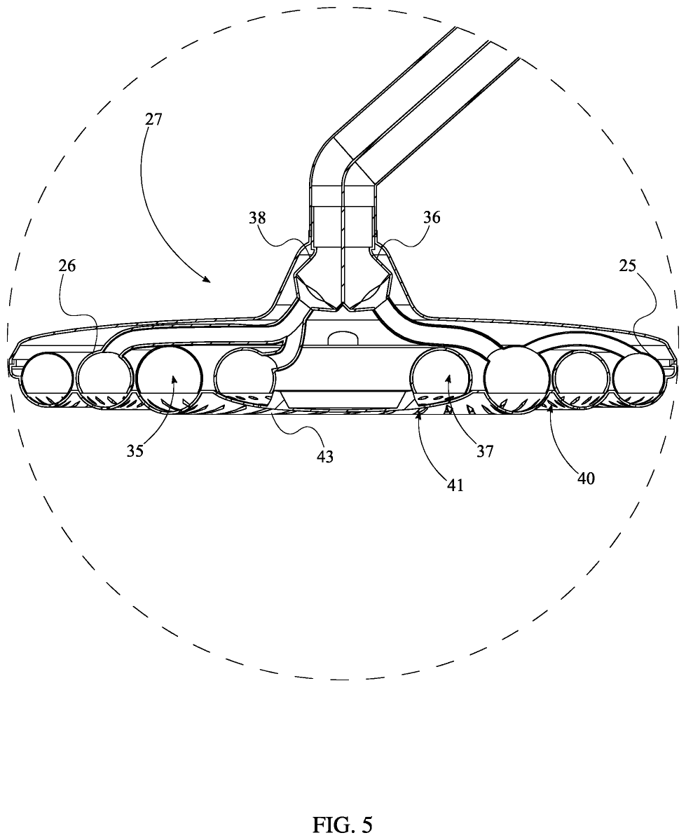

In reference to FIGS. 4 and 5, the first annular chamber 25 is selectably connected to the first conduit 22 across the fluid selection mechanism 24 and the second annular chamber 26 is selectably connected to the second conduit 23 across the fluid selection mechanism 24. As shown, the first annular chamber 25 and the second annular chamber 26 ideally constitute discrete manifold structures suitable for distributing and directing any type or variety of fluid flow throughout the dispersal head 27. The exemplary concentric arrangement of the first annular chamber 25 and the second annular chamber 26 represents a preferred embodiment, wherein the contents of first fluid supply 20 and the second fluid supply 21 are equally distributed into the target region 28 from approximately equidistant locations. However, in multiple other embodiments this arrangement may be parallel, overlapped, or angularly offset in any aesthetic fashion without departing from the original spirit and scope of the present invention.

Further, as shown in FIGS. 5, 8, and 9, the first annular chamber 25 and the second annular chamber 26 are superimposed onto the dispersal head 27 such that the interior volumes of both the first annular chamber 25 and the second annular chamber 26 are exposed to the target region 28 through the dispersal head 27. In the preferred embodiment shown. the first annular chamber 25 and the second annular chamber 26 are permanently connected to the dispersal head 27 to maintain the manifold integrity of both the first annular chamber 25 and the second annular chamber 26, wherein the dispersal head 27 forms an integral wall of each component. This arrangement simplifies the geometry of the first annular chamber 25 and the second annular chamber 26, as both components are not necessarily closed, manifold shapes before being attached to the dispersal head 27. The accordant benefits to manufacturable design are proposed as a benefit of the preferred embodiment but should not be construed as a limitation to the overall spirit and scope of the present invention. In the broadest terms, the first annular chamber 25 and the second annular chamber 26 are arranged to enable a normalized dispersal pattern of fluids across the dispersal head 27 when pressurized via the fluid selection mechanism 24. Consequently, the first fluid supply 20 and the second fluid supply 21 are dispensed through the dispersal head 27 and are in selectable communication with the target region 28.

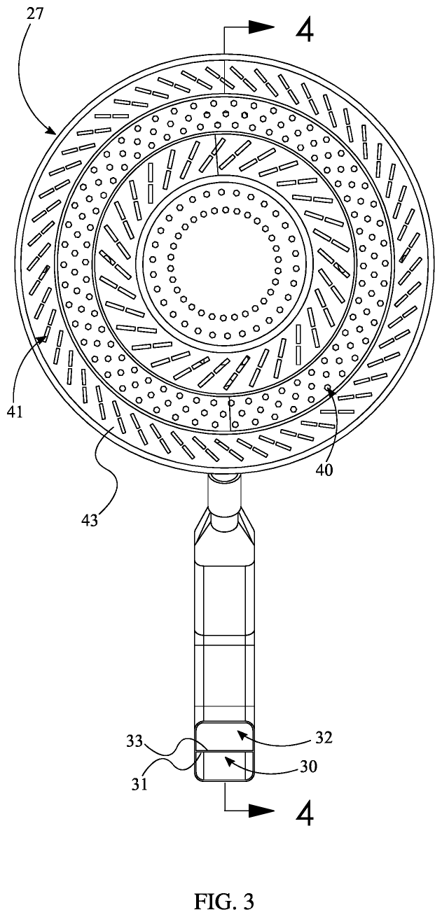

It is further considered that the unique construction of the dispersal head 27 may require an accordantly unique means of feeding fluid into such an arrangement. Accordingly, the first conduit 22 may comprise a first passage 30 and a first planar sidewall 31 and the second conduit 23 may comprise a second passage 32 and a second planar sidewall 33 as indicated in FIGS. 3 and 4. The first passage 30 and the second passage 32 define sealed, discrete tubes or pipes configured to transport the contents of the first fluid supply 20 and the second fluid supply 21, as previously outlined. The first planar sidewall 31 and the second planar sidewall 33 each represent flattened segments of the first passage 30 and the second passage 32, respectively. As shown in FIGS. 1 and 2, these geometric irregularities in a normally rounded pipe enable the first passage 30 and the second passage 32 to be arranged adjacent to each other while retaining a generally conventional external diameter. Accordingly, the first planar sidewall 31 is mounted to the second planar sidewall 33 as shown in FIG. 3, thereby enabling the first conduit 22 and the second conduit 23 to replace existing, conventional plumbing with a minimal of additional modification. This functionality is critical in retrofit operations, where the present invention is applied to existing infrastructure (conventional feed pipes, terminal connections, flow controls, etc.).

In reference to FIGS. 5, 8, and 9, the first annular chamber 25 may comprise a first circuit 35 and a first distributor 36. Further, the second annular chamber 26 may comprise a second circuit 37 and a second distributor 38. The first circuit 35 and the second circuit 37 broadly define the enclosed volumes and capacities of the first annular chamber 25 and the second annular chamber 26, respectively. The first circuit 35 and the second circuit 37 are mounted into the dispersal head 27, proximal to the target region 28, such that the first circuit 35 and the second circuit 37 are immediately positioned to direct the final dispensation of fluids from therein. In reference to FIGS. 4 and 5, the first distributor 36 is connected between the fluid selection mechanism 24 and the first circuit 35 such that the first circuit 35 is equally and completely pressurized by any incoming volume of fluid from the first fluid supply 20 through the fluid selection mechanism 24. Likewise, the second distributor 38 is connected between the fluid selection mechanism 24 and the second circuit 37 such that the second circuit 37 is equally and completely pressurized by any incoming volume of fluid from the second fluid supply 21 through the fluid selection mechanism 24. Further, as indicated in FIG. 5, the first distributor 36 and the second distributor 38 protrude from the dispersal head 27, opposite the target region 28, enabling the exposed sections of the first distributor 36 and the second distributor 38 to function as terminal connections to the fluid selection mechanism 24. In at least one embodiment, this arrangement enables the modularization of the dispersal head 27, the first annular chamber 25, and the second annular chamber 26 as a direct functional replacement for a conventional shower head.

In reference to FIG. 3, the dispersal head 27 may comprise a plurality of first apertures 40 and a plurality of second apertures 41. The plurality of first apertures 40 is configured to enable the effective expulsion of fluid therethrough, according to the type and viscosity of material provided from the first fluid supply 20. Likewise, the plurality of second apertures 41 is configured according to the same metrics of the material provided from the second fluid supply 21. Accordingly, the plurality of first apertures 40 is positioned adjacent to the first annular chamber 25 and the plurality of second apertures 41 is positioned adjacent to the second annular chamber 26. Expelling the first fluid supply 20 and the second fluid supply 21 through a differentiated set of the plurality of first apertures 40 and the plurality of second apertures 41 enables the present invention to handle vastly different fluid types, i.e., the combination of a water-washing function combined with a hot-air drier function. The gross differences in fluid viscosity between these exemplary fluids suggests that the plurality of first apertures 40 may each be constricted to optimize the outflow of water, while the plurality of second apertures 41 may each be expanded to maximize the outflow of air.

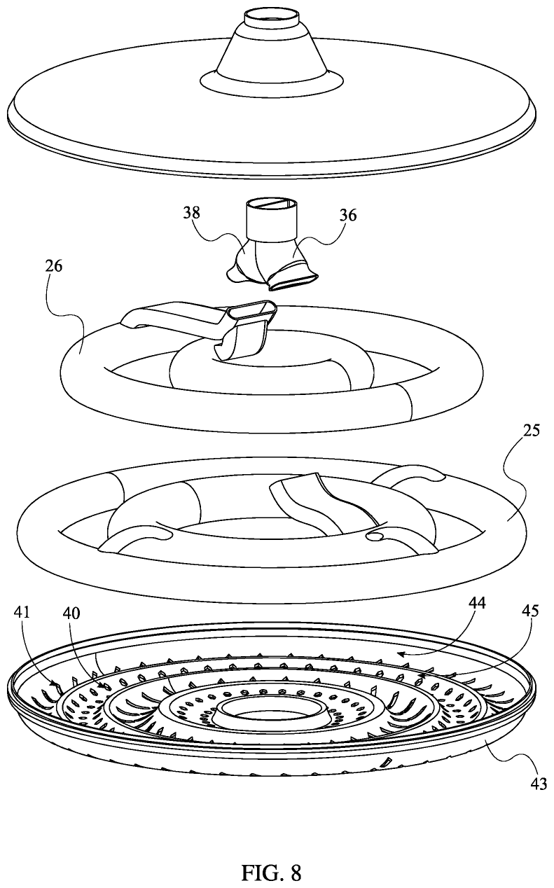

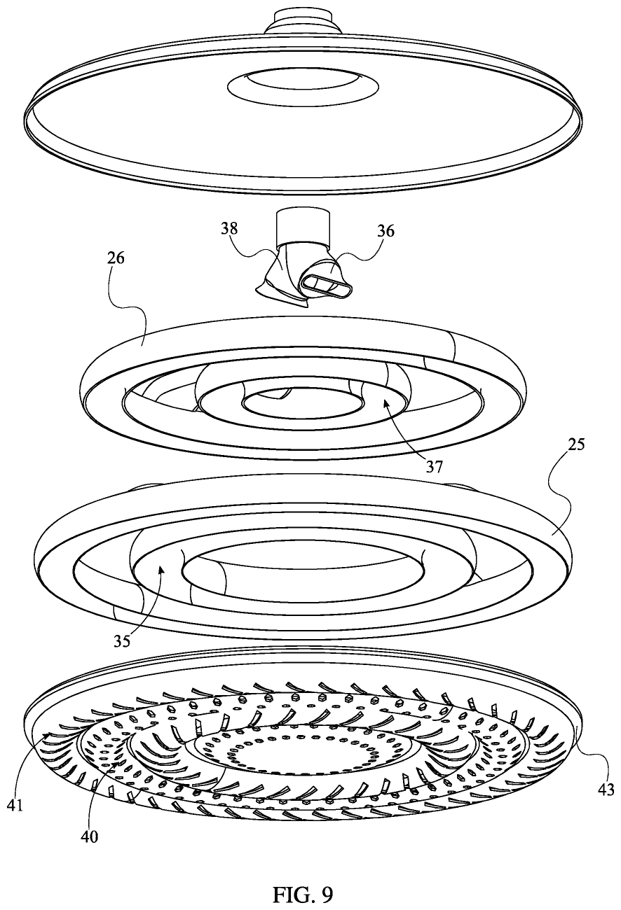

It is further considered that the dispersal head 27 may constitute a user-assembled, modular component of the present invention. The interchange of similar, inter-compatible components between comparable embodiments may enable a user to tailor their apparatus to suit a wide variety of use-cases. Accordingly, the dispersal head 27 may comprise a diffuser panel 43, a plurality of first channels 44, and a plurality of second channels 45 as indicated in FIGS. 8 and 9. The diffuser panel 43 constitutes a permeable sidewall or panel supporting the dispersal of fluid therethrough, generally embodying the nozzle-plate of a conventional showerhead. The plurality of first channels 44 is positioned on the diffuser panel 43, with the plurality of second channels 45 also positioned on the diffuser panel 43. The plurality of second channels 45 is arranged concentric to the plurality of first channels 44, mirroring the preferred arrangement of the first annular chamber 25 and the second annular chamber 26.

As shown in FIG. 8, the plurality of first channels 44 and the plurality of second channels 45 constitute a series of concave formations into the diffuser panel 43, positioned to index and supports the first annular chamber 25 and the second annular chamber 26 into operable positions in relation to the diffuser panel 43. Accordingly, the first annular chamber 25 is mounted into the plurality of first channels 44 in fluid communication with the target region 28 through the diffuser panel 43. Likewise, the second annular chamber 26 is also mounted into the plurality of second channels 45 in fluid communication with the target region 28 through the diffuser panel 43. It is broadly contemplated that the first annular chamber 25 and the second annular chamber 26 may be removed from the diffuser panel 43, thereby enabling the exchange of any detached components as modular elements of the dispersal head 27. This includes, for example, the exchange of the first annular chamber 25 from the plurality of first channels 44 to accommodate any conceivable fluid therein, and the exchange of the diffuser panel 43 to adjust the dispersal pattern and volume.

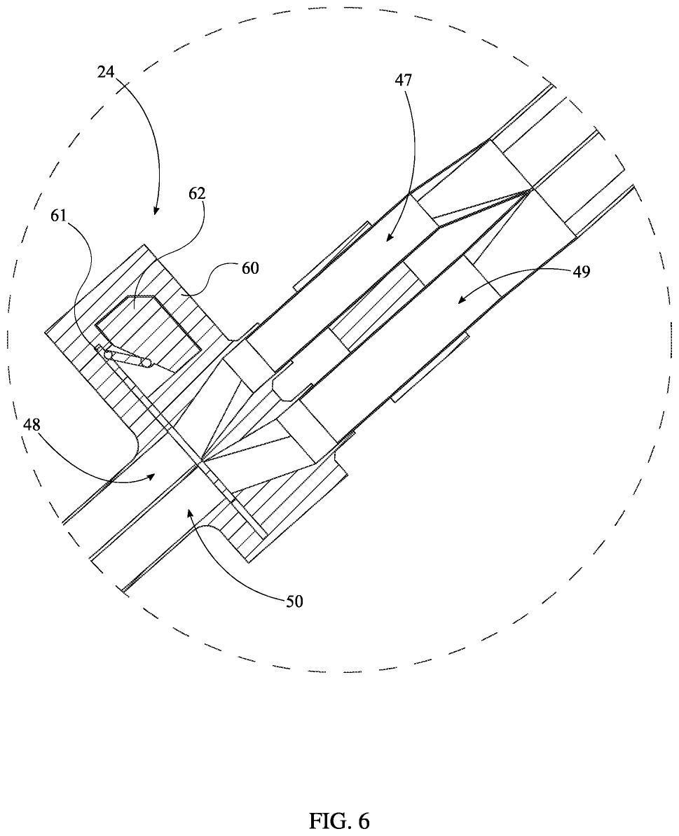

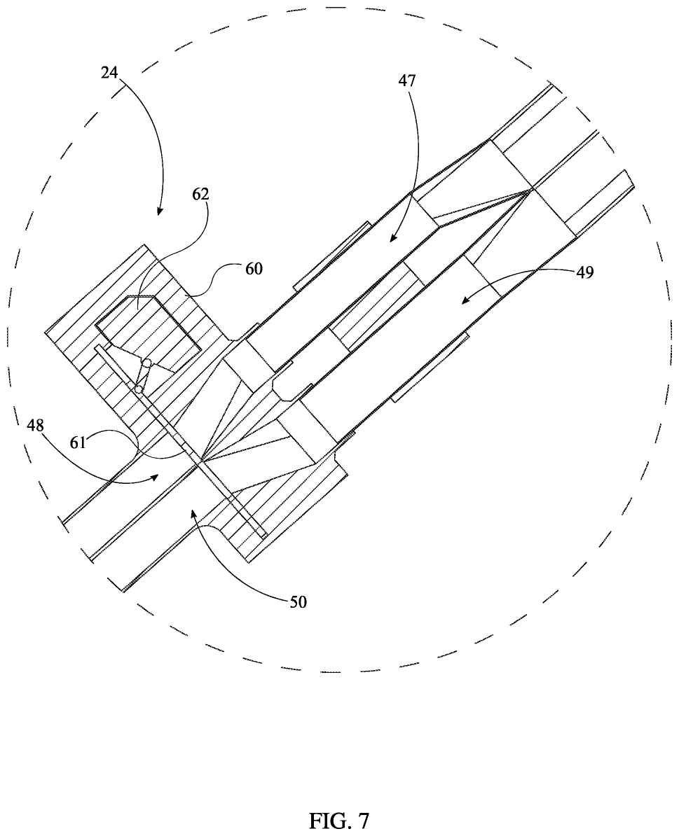

As outlined above, the present invention provides a means to selectable shift between outputting from the first fluid supply 20 to the second fluid supply 21 using the fluid selection mechanism 24. As indicated in FIGS. 6 and 7, the fluid selection mechanism 24 comprises a valve body 60, a gate 61, an actuator 62, a first inlet 47, a first outlet 48, a second inlet 49, and a second outlet 50. The valve body 60 refers to the sealed structural body into which the other components of the fluid selection mechanism 24 are formed and mounted. The gate 61 constitutes a means of obstructing the flow of either the first inlet 47 or the second inlet 49 under force from the actuator 62, as shown in a bistable configuration in FIGS. 6 and 7. In the exemplary configuration a servomotor and sluice assembly are used for illustration purposes, but the ultimate embodiment of the actuator 62 and gate 61 may constitute any type of fluid control valve system as may be realized by a reasonably skilled individual across multiple potential embodiments.

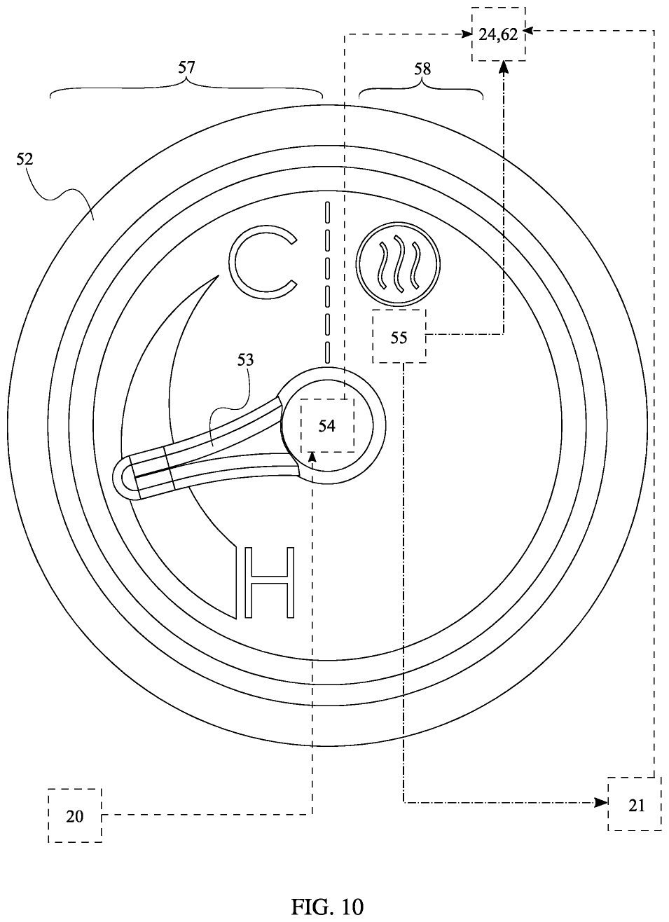

It is also considered that a common use-case for the present invention requires the retrofit of existing showerheads and facilities to support the unique functions described herein. More specifically, the user of the present invention must provide a means to trigger and moderate the output of various fluids from the first fluid supply 20 and the second fluid supply 21 that incorporates existing, conventional control schema. As illustrated in FIG. 10 through 12, the fluid selection mechanism 24 may further comprise a rotary dial 52, a selector handle 53, a mixture control element 54, and at least one positional switch 55. The rotary dial 52, selector handle 53, and mixture control element 54 ideally constitute existing fixtures for a conventional shower. As shown, the rotary dial 52 and the selector handle 53 are configured to visually guide a user in selecting an appropriate hot-cold mixture in conjunction with the mixture control element 54 that is rigidly mounted to the rotary dial 52. The selector handle 53 is rotatably mounted to the mixture control element 54 across the rotary dial 52, enabling the manual moderation of the mixture control element 54. This arrangement generally defines a means of operating the first fluid supply 20, wherein the first fluid supply 20 is presented as a residential water source for exemplary purposes. Departing from conventional structures, the at least one positional switch 55 is mounted to the rotary dial 52 offset from the selector handle 53 to enable the activation and moderation of the second fluid source, e.g., an electric hair dryer. The positioning of the at least one positional switch 55 onto the otherwise-conventional rotary dial 52 enables the otherwise-conventional selector handle 53 to be employed as a controller for both the first fluid supply 20 and the second fluid supply 21 with minimal modification to conventional shower facilities. In practice, the at least one positional switch 55 may be installed directly into existing shower controls at the limit of said existing controls' adjustment range, wherein the closure of the mixture control element 54 corresponds and coincides with the activation of the at least one positional switch 55. This functional arrangement is ideally employed in conjunction with an electronically operated embodiment of the fluid selection mechanism 24, wherein the activation and deactivation of the at least one positional switch 55 corresponds to binary modes of operation. I.e., the first fluid supply 20 and the second fluid supply 21 are selectably applied to the target region 28 based upon the actuation of the actuator 62 as shown in FIGS. 6 and 7. Likewise, the activation of the at least one positional switch 55 may be configured to simultaneously activate the second fluid supply 21, pressurizing said second fluid supply 21 into the second conduit 23.

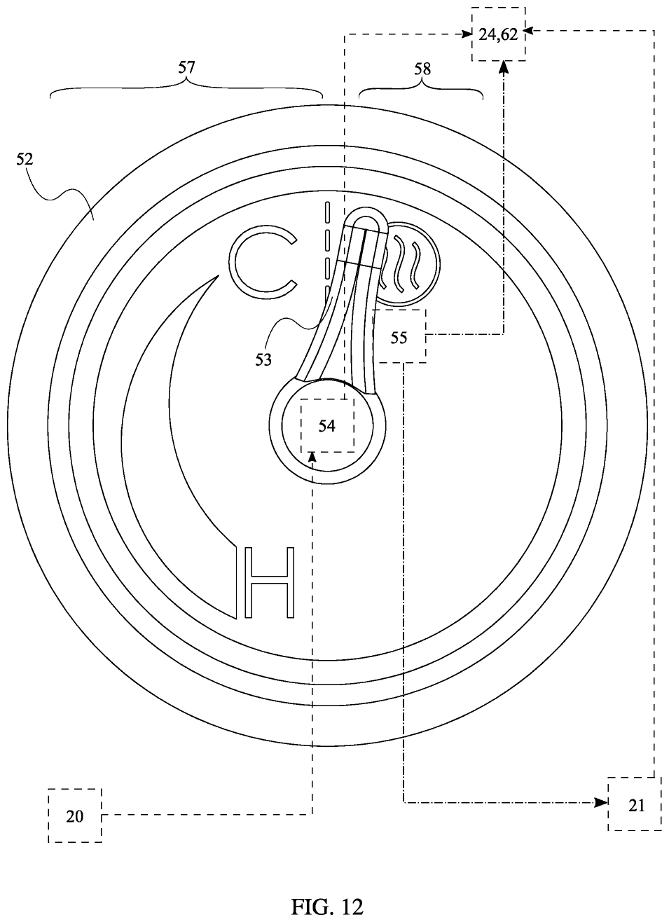

It is further proposed that the rotary dial 52 may be configured specifically for use with the present invention in some embodiments, rather than utilizing existing hardware to fulfill the above-described functions. Accordingly, the rotary dial 52 may comprise a first selection zone 57 and a second selection zone 58 as shown in FIGS. 10 and 12. The first selection zone 57 corresponds to the operating range of the mixture control element 54 as outlined, wherein the maximal and minimal angular positions of the selector handle 53 correspond to all-hot-water output, through all-cold-water output, and closure of the mixture control element 54. The second selection zone 58 is positioned adjacent to the first selection zone 57, with the at least one positional switch 55 being positioned in the second selection zone 58. Rotating the selection lever into the second selection zone 58 actuates the at least one positional switch 55, generating an operable command to the second fluid supply 21 to trigger and moderate functions thereof.

In a preferred and exemplary embodiment of the present invention, the first fluid supply 20 is a mixed water tap and the second fluid supply 21 is a heated air pump. The closure of the mixture control element 54 in this embodiment corresponds to a limitation of the first fluid supply 20 indirectly, with the actuation of the at least one positional switch 55 further providing operable commands to the second fluid supply 21 to start and cease functions. The combination of fluid flow controls and electronic controls utilized in this embodiment is specifically considered to provide a retrofit capacity to existing shower facilities, wherein the control schema for the second fluid supply 21 is provided with only the installation of the at least one positional switch 55. Further, the at least one positional switch 55 may provide operable commands to other flow-limiting components of the fluid selection device in general, whereby the flow of fluid throughout the present invention may be moderated utilizing electronic valves by any means and methods as may be realized by any reasonably skilled individual.

Although the invention has been explained in relation to its preferred embodiment, it is to be understood that many other possible modifications and variations can be made without departing from the spirit and scope of the invention as hereinafter claimed.

What is claimed is:

1. A hybridized shower apparatus comprising:
a first fluid supply;
a second fluid supply;
a first conduit;
a second conduit;
a fluid selection mechanism;
a first annular chamber;
a second annular chamber;
a dispersal head;
the first conduit being connected between the fluid selection mechanism and the first fluid supply;
the second conduit being connected between the fluid selection mechanism and the second fluid supply;
the first annular chamber being selectably connected to the first conduit across the fluid selection mechanism;
the second annular chamber being selectably connected to the second conduit across the fluid selection mechanism; and
the first annular chamber and the second annular chamber being superimposed onto the dispersal head, wherein the first fluid supply and the second fluid supply are in selectable communication with a target region.

2. The hybridized shower apparatus comprising as claimed in claim 1 comprising:
the first conduit comprising a first passage and a first planar sidewall;
the second conduit comprising a second passage and a second planar sidewall; and
the first planar sidewall being mounted to the second planar sidewall.

3. The hybridized shower apparatus comprising as claimed in claim 1 comprising:
the first annular chamber comprising a first circuit and a first distributor;
the second annular chamber comprising a second circuit and a second distributor;
the first circuit and the second circuit being mounted into the dispersal head, proximal to the target region;
the first distributor being connected between the fluid selection mechanism and the first circuit;
the second distributor being connected between the fluid selection mechanism and the second circuit; and
the first distributor and the second distributor protruding from the dispersal head, opposite the target region.

4. The hybridized shower apparatus comprising as claimed in claim 1 comprising:
the dispersal head comprising a plurality of first apertures and a plurality of second apertures;
the plurality of first apertures being positioned adjacent to the first annular chamber; and
the plurality of second apertures being positioned adjacent to the second annular chamber.

5. The hybridized shower apparatus comprising as claimed in claim 1 comprising:
the dispersal head comprising a diffuser panel, a plurality of first channels, and a plurality of second channels;
the plurality of first channels being positioned on the diffuser panel;
the plurality of second channels being positioned on the diffuser panel, concentric to the plurality of first channels;
the first annular chamber being mounted into the plurality of first channels in fluid communication with the target region through the diffuser panel; and
the second annular chamber being mounted into the plurality of second channels in fluid communication with the target region through the diffuser panel.

6. The hybridized shower apparatus comprising as claimed in claim 1 comprising:
the fluid selection mechanism comprising a valve body, a gate, an actuator, a first inlet, a first outlet, a second inlet, and a second outlet;
the first inlet traversing the valve body between the gate and the first conduit;
the first outlet traversing the valve body between the gate and the first annular chamber;
the second inlet traversing the valve body between the gate and the second conduit;
the second outlet traversing the valve body between the gate and the second annular chamber; and
the actuator being operably connected between the gate and the valve body, wherein the actuator selectably obstructs the first inlet or the second outlet.

7. The hybridized shower apparatus comprising as claimed in claim 6 comprising:
the fluid selection mechanism comprising a rotary dial, a selector handle, a mixture control element, and at least one positional switch;
the mixture control element being rigidly mounted to the rotary dial;
the selector handle being rotatably mounted to the mixture control element across the rotary dial; and
the at least one positional switch being mounted to the rotary dial offset from the selector handle.

8. The hybridized shower apparatus comprising as claimed in claim 7 comprising:
the rotary dial comprising a first selection zone and a second selection zone;
the first selection zone corresponding to the operating range of the mixture control element;
the second selection zone being positioned adjacent to the first selection zone; and
the at least one positional switch being positioned in the second selection zone.

9. The hybridized shower apparatus comprising as claimed in claim 1, wherein the first fluid supply is a mixed water tap and the second fluid supply is a heated air pump.

10. A hybridized shower apparatus comprising:
a first fluid supply;
a second fluid supply;
a first conduit;
a second conduit;
a fluid selection mechanism;
a first annular chamber;
a second annular chamber;
a dispersal head;
the first conduit being connected between the fluid selection mechanism and the first fluid supply;
the second conduit being connected between the fluid selection mechanism and the second fluid supply;
the first annular chamber being selectably connected to the first conduit across the fluid selection mechanism;
the second annular chamber being selectably connected to the second conduit across the fluid selection mechanism;
the first annular chamber and the second annular chamber being superimposed onto the dispersal head, wherein the first fluid supply and the second fluid supply are in selectable communication with a target region;
the fluid selection mechanism comprising a valve body, a gate, an actuator, a first inlet, a first outlet, a second inlet, and a second outlet;
the first inlet traversing the valve body between the gate and the first conduit;
the first outlet traversing the valve body between the gate and the first annular chamber;
the second inlet traversing the valve body between the gate and the second conduit;
the second outlet traversing the valve body between the gate and the second annular chamber;
the actuator being operably connected between the gate and the valve body, wherein the actuator selectably obstructs the first inlet or the second outlet;
the fluid selection mechanism comprising a rotary dial, a selector handle, a mixture control element, and at least one positional switch;
the mixture control element being rigidly mounted to the rotary dial;
the selector handle being rotatably mounted to the mixture control element across the rotary dial; and
the at least one positional switch being mounted to the rotary dial offset from the selector handle.

11. The hybridized shower apparatus comprising as claimed in claim 10 comprising:
the first conduit comprising a first passage and a first planar sidewall;
the second conduit comprising a second passage and a second planar sidewall; and
the first planar sidewall being mounted to the second planar sidewall.

12. The hybridized shower apparatus comprising as claimed in claim 10 comprising:
the first annular chamber comprising a first circuit and a first distributor;
the second annular chamber comprising a second circuit and a second distributor;
the first circuit and the second circuit being mounted into the dispersal head, proximal to the target region;
the first distributor being connected between the fluid selection mechanism and the first circuit;
the second distributor being connected between the fluid selection mechanism and the second circuit; and
the first distributor and the second distributor protruding from the dispersal head, opposite the target region.

13. The hybridized shower apparatus comprising as claimed in claim 10 comprising:
the dispersal head comprising a plurality of first apertures and a plurality of second apertures;
the plurality of first apertures being positioned adjacent to the first annular chamber; and
the plurality of second apertures being positioned adjacent to the second annular chamber.

14. The hybridized shower apparatus comprising as claimed in claim 10 comprising:
the dispersal head comprising a diffuser panel, a plurality of first channels, and a plurality of second channels;
the plurality of first channels being positioned on the diffuser panel;
the plurality of second channels being positioned on the diffuser panel, concentric to the plurality of first channels;
the first annular chamber being mounted into the plurality of first channels in fluid communication with the target region through the diffuser panel; and
the second annular chamber being mounted into the plurality of second channels in fluid communication with the target region through the diffuser panel.

15. The hybridized shower apparatus comprising as claimed in claim 10 comprising:
the rotary dial comprising a first selection zone and a second selection zone;
the first selection zone corresponding to the operating range of the mixture control element;
the second selection zone being positioned adjacent to the first selection zone; and
the at least one positional switch being positioned in the second selection zone.

16. The hybridized shower apparatus comprising as claimed in claim 10, wherein the first fluid supply is a mixed water tap and the second fluid supply is a heated air pump.

17. A hybridized shower apparatus comprising:
a first fluid supply;
a second fluid supply;
a first conduit;
a second conduit;
a fluid selection mechanism;
a first annular chamber;
a second annular chamber;
a dispersal head;
the first conduit being connected between the fluid selection mechanism and the first fluid supply;
the second conduit being connected between the fluid selection mechanism and the second fluid supply;
the first annular chamber being selectably connected to the first conduit across the fluid selection mechanism;
the second annular chamber being selectably connected to the second conduit across the fluid selection mechanism;
the first annular chamber and the second annular chamber being superimposed onto the dispersal head, wherein the first fluid supply and the second fluid supply are in selectable communication with a target region;
the fluid selection mechanism comprising a valve body, a gate, an actuator, a first inlet, a first outlet, a second inlet, and a second outlet;
the first inlet traversing the valve body between the gate and the first conduit;
the first outlet traversing the valve body between the gate and the first annular chamber;
the second inlet traversing the valve body between the gate and the second conduit;
the second outlet traversing the valve body between the gate and the second annular chamber;
the actuator being operably connected between the gate and the valve body, wherein the actuator selectably obstructs the first inlet or the second outlet;
the fluid selection mechanism comprising a rotary dial, a selector handle, a mixture control element, and at least one positional switch;
the mixture control element being rigidly mounted to the rotary dial;
the selector handle being rotatably mounted to the mixture control element across the rotary dial;
the at least one positional switch being mounted to the rotary dial offset from the selector handle;
the rotary dial comprising a first selection zone and a second selection zone;
the first selection zone corresponding to the operating range of the mixture control element;
the second selection zone being positioned adjacent to the first selection zone;
the at least one positional switch being positioned in the second selection zone;
the dispersal head comprising a plurality of first apertures and a plurality of second apertures;
the plurality of first apertures being positioned adjacent to the first annular chamber;
the plurality of second apertures being positioned adjacent to the second annular chamber;
the dispersal head comprising a diffuser panel, a plurality of first channels, and a plurality of second channels;
the plurality of first channels being positioned on the diffuser panel;
the plurality of second channels being positioned on the diffuser panel, concentric to the plurality of first channels;
the first annular chamber being mounted into the plurality of first channels in fluid communication with the target region through the diffuser panel; and
the second annular chamber being mounted into the plurality of second channels in fluid communication with the target region through the diffuser panel.

18. The hybridized shower apparatus comprising as claimed in claim 17 comprising:
the first conduit comprising a first passage and a first planar sidewall;
the second conduit comprising a second passage and a second planar sidewall; and
the first planar sidewall being mounted to the second planar sidewall.

19. The hybridized shower apparatus comprising as claimed in claim 17 comprising:
the first annular chamber comprising a first circuit and a first distributor;
the second annular chamber comprising a second circuit and a second distributor;
the first circuit and the second circuit being mounted into the dispersal head, proximal to the target region;
the first distributor being connected between the fluid selection mechanism and the first circuit;
the second distributor being connected between the fluid selection mechanism and the second circuit; and
the first distributor and the second distributor protruding from the dispersal head, opposite the target region.

20. The hybridized shower apparatus comprising as claimed in claim 10, wherein the first fluid supply is a mixed water tap and the second fluid supply is a heated air pump.
